(19) United States
(12) Patent Application Publication
(10) Pub. No.: US 2015/0170602 A1
(43) Pub. Date: Jun. 18, 2015

(54) APPARATUS AND METHOD FOR STABILIZING IMAGE OF DISPLAY

(71) Applicant: SAMSUNG ELECTRO-MECHANICS CO., LTD., Gyeonggi-Do (KR)

(72) Inventor: Soon Seok KANG, Gyeonggi-Do (KR)

(73) Assignee: SAMSUNG ELECTRO-MECHANICS CO., LTD., Gyeonggi-Do (KR)

(21) Appl. No.: 14/301,035

(22) Filed: Jun. 10, 2014

(30) Foreign Application Priority Data
Dec. 18, 2013 (KR) 10-2013-0158251

(51) Int. Cl. G09G 5/00; G06T 5/00

(52) U.S. Cl. CPC G09G 5/00; G06T 5/002; G09G 2320/0247; G09G 2320/0261; G06T 2207/20201

(57) ABSTRACT

Embodiments of the invention provide an apparatus for stabilizing an image of a display. The apparatus includes a motion detector configured to detect a motion of the display, and an image distortion corrector configured to correct positions of pixels of an image signal input into a display driver based on an output of the motion detector. Embodiments also include a method for stabilizing an image of a display. The method includes the steps of (A) detecting a motion of the display by a motion detector, and (B) correcting positions of pixels of an image signal input into a display driver based on an output of the motion detector.

### CROSS REFERENCE TO RELATED APPLICATION

This application claims the benefit of and priority under 35 U.S.C. §119 to Korean Patent Application No. KR 10-2013-0158251, entitled “APPARATUS AND METHOD FOR STABILIZING IMAGE OF DISPLAY,” filed on Dec. 18, 2013, which is hereby incorporated by reference in its entirety into this application.

### BACKGROUND

1. Field of the Invention

The present invention relates to an apparatus and a method for stabilizing an image of a display by using a motion sensor, such as a gyro sensor.

2. Description of the Related Art

When a user reads the newspaper or a book using a mobile device, such as a smart phone or a tablet in a bus or subway, it is a main drawback that a display is shaken due to a shaking of the mobile device in an environment in which a vibration is present, such that the user may not clearly view the newspaper or the book displayed on the display. As a result, it causes fatigue of the mind and body of the user, such that concentration of the user may be degraded.

Korean Patent Publication No. KR 10-2008-0023070 describes a mobile terminal for receiving digital broadcasting and a method for maintaining the horizontal of video, describes a mobile terminal for receiving digital broadcasting capable of displaying an output digital broadcasting video on a screen so as to be horizontal with a paper, and a method for maintaining the horizontal of video. According to this reference, the digital broadcasting video may be displayed to be horizontal with the paper regardless of a rotation angle of the screen. However, the mobile terminal for receiving digital broadcasting and the method for maintaining the horizontal of video may have a problem in that the user may not clearly view the newspaper or the book displayed on the display due to the shaking of the display when viewing the newspaper or the book using the mobile device such as the smart phone or the tablet in the bus or subway.

### SUMMARY

Accordingly, embodiments of the invention have been made in an effort to provide an apparatus for stabilizing an image of a display capable of decreasing eye fatigue of a user and increasing quality of the image by correcting distortion of the image displayed on the display even in the case in which the display is shaken due to external vibration or the hand-shake of a user to thereby display a clear image which has no shaking.

Furthermore, embodiments of the invention have been made in an effort to provide a method for stabilizing an image of a display capable of decreasing eye fatigue of a user and increasing quality of the image by correcting distortion of the image displayed on the display even in the case in which the display is shaken due to external vibration or the hand-shake of a user to thereby display a clear image having no shaking.

According to an embodiment of the invention, there is provided an apparatus for stabilizing an image of a display, the apparatus including a motion detector configured to detect a motion of the display, and an image distortion corrector configured to correct positions of pixels of an image signal input into a display driver based on an output of the motion detector.

According to an embodiment, the image distortion corrector is further configured to correct the positions of the pixels of an image signal output from an application processor or an image signal processor based on the motion detected by the motion detector and configured to provide the corrected pixels to the display driver.

According to an embodiment, the image distortion corrector may shift the positions of the pixels of the image signal input into the display driver to a direction opposite to a direction in which the display is moved to thereby correct image distortion due to the motion of the display.

According to an embodiment, the motion detector includes at least one gyro sensor configured to sense the motion of the display, a gyro interface configured to transform and output an output format of the at least one gyro sensor, and a filter connected to the gyro interface and configured to remove a drift error and an offset error from an output of the gyro sensor.

According to an embodiment, the image distortion corrector includes an angular velocity-distance calculator configured to calculate a movement distance of the display based on an angular velocity output from the gyro interface, a sync and pixel position calculator configured to calculate a new sync and pixel position based on the movement distance of the display output from the angular velocity-distance calculator, a memory controller configured to shift the positions of the pixels of an input image signal based on an output of the sync and pixel position calculator, a memory connected to the memory controller and configured to store the input image signal, an interpolator configured to generate pixels to be filled in an empty space caused by the shift of the pixels in the image signal output from the memory controller, and a sync and image configuring unit configured to configure a sync and image for the interpolated image signal output from the interpolator.

According to an embodiment, the image distortion corrector further includes a hand-shake determining unit configured to determine whether a hand-shake of a user is an intended hand-shake based on the output of the angular velocity-distance calculator and configured to provide a hand-shake determining signal and the movement distance of the display output from the angular velocity-distance calculator to the sync and pixel position calculator.

According to an embodiment, the hand-shake determining unit is configured to calculate a displacement amount accumulated during one frame based on the output of the motion detector and configured to compare the accumulated displacement amount with a predetermined reference value to thereby determine whether the hand-shake of the user is the intended hand-shake.

According to an embodiment, when the hand-shake determining signal output from the hand-shake determining unit represents that the hand-shake of the user is the intended hand-shake, the sync and pixel position calculator provides a signal, which includes an indication of not calculating a new sync and pixel position and bypassing an original image signal to the memory controller.

According to an embodiment, the memory controller is configured to read out and output the image signal stored in the memory depending on the new sync and pixel position output from the sync and pixel position calculator to thereby shift an image to an X-Y-Z axis.

According to an embodiment, the image distortion corrector is configured to correct the positions of the pixels of the image signal input into the display driver in an X-Y axis direction depending on a shaking of an X-Y axis of the display, when the at least one gyro sensor is a two-axis gyro sensor, and further configured to correct the positions of the pixels of the image signal input into the display driver in an X-Y-Z axis direction depending on a shaking of an X-Y-Z axis of the display, when the at least one gyro sensor is a three-axis gyro sensor.

According to another embodiment of the invention, there is provided a method for stabilizing an image of a display, the method including (A) detecting a motion of the display by a motion detector; and (B) correcting positions of pixels of an image signal input into a display driver based on an output of the motion detector.

According to an embodiment, step (B) further includes correcting the positions of the pixels of an image signal output from an application processor or an image signal processor based on the motion detected by the motion detector and providing the corrected pixels to the display driver.

According to an embodiment, step (B) includes shifting the positions of the pixels of the image signal input into the display driver to a direction opposite to a direction in which the display is moved to thereby correct image distortion due to the motion of the display.

According to an embodiment, step (B) further includes (B1) calculating a movement distance of the display based on an angular velocity in response to the motion of the display output from the step (A), (B2) calculating a new sync and pixel position based on the movement distance of the display, (B3) shifting the positions of the pixels of an input image signal based on the new sync and pixel position, (B4) generating pixels to be filled in an empty space caused by the shift in the image signal in which the positions of the pixels are shifted in the step (B3) by interpolating pixels in the same frame to thereby generate an interpolated image signal, and (B5) configuring a sync and image for the interpolated image signal.

According to an embodiment, the method further includes, after step (B1), (B1-1) determining whether a hand-shake of a user is an intended hand-shake based on the movement distance of the display and providing a hand-shake determining signal and the movement distance of the display calculated by the step (B1).

According to an embodiment, step (B1-1) includes calculating a displacement amount accumulated during one frame based on the movement distance of the display and comparing the accumulated displacement amount with a predetermined reference value to thereby determine whether the hand-shake of the user is the intended hand-shake.

According to an embodiment, when the hand-shake determining signal output from step (B1-1) represents that the hand-shake of the user is the intended hand-shake, step (B2) includes outputting a signal, which includes an indication of not calculating a new sync and pixel position and bypassing an original image signal.

According to an embodiment, step (B3) includes reading out and outputting the image signal stored in a memory depending on the new sync and pixel position to thereby shift the positions of the pixels of an image to an X-Y-Z axis.

According to an embodiment, in step (A), when the motion of the display depending on a hand-shake of a user is detected using at least one two-axis gyro sensor, step (B) includes correcting the positions of the pixels of the image signal input into the display driver in an X-Y axis direction depending on a shaking of an X-Y axis of the display based on an output of the at least one two-axis gyro sensor, and in step (A), when the motion of the display depending on a hand-shake of a user is detected using at least one three-axis gyro sensor, step (B) includes correcting the positions of the pixels of the image signal input into the display driver in an X-Y-Z axis direction depending on a shaking of an X-Y-Z axis of the display based on an output of the at least one three-axis gyro sensor.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a view showing an internal configuration of a general display driver according to an embodiment of the invention.

FIG. 2 is a block diagram of an apparatus for stabilizing an image of a display according to an embodiment of the invention.

FIG. 3 is a flow chart of a method for stabilizing an image of a display according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

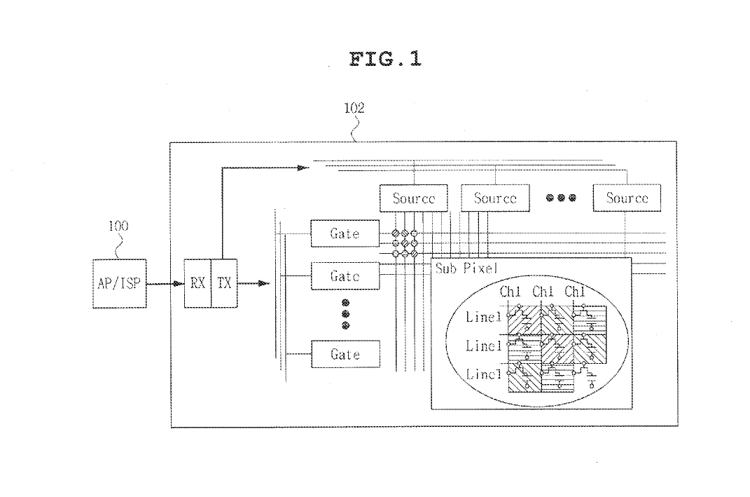

FIG. 1 is a view showing an internal configuration of a general display driver according to an embodiment of the invention. In general, an application processor (AP) or an image signal processor (ISP) 100 provides an image to a display driver 102 without changing any image in providing the image to be displayed on a display to the display driver 102, and the display driver 102 drives a gate driver (Gate) based on information which is simply input.

The display driver 102 displays the image on the display by simply turning on or off the gate driver. The application processor or the image signal processor 100 and the display driver 102 do not have a function of correcting distortion of the image due to an external vibration or a hand-shake of the user.

According to an embodiment of the invention, an image transmitted to the display driver by the application processor is reconfigured by using a motion detector, such as a gyro sensor, thereby making it possible to prevent the image displayed on the display from being shaken and distorted due to the shaking of the display.

According to an embodiment of the invention, an image distortion corrector for correcting distortion of the image due to a vibration is inserted into a front state of an input of the display driver. As a result, the image is transformed, so that the display displays a corrected image different from the image transmitted from the application processor or the image signal processor, thereby making it possible to obtain a result of decreasing the degree of eye fatigue and increasing definition of the image. According to an embodiment of the invention, the function described above may be implemented using the gyro sensor, a three-dimensional transformation of the image, interpolation, a memory control, as non-limiting examples.

According to an embodiment of the invention, in an environment in which the vibration is present such as a bus or subway, when a display of a mobile device, such as a smart phone or a tablet is shaken, an image display on the display is shifted to a direction opposite to a direction in which the display is shaken, that is, up or down, left or right, or front or rear. Therefore, even though the display is shaken by the vibration, a blurring of the image displayed on the display may be significantly decreased and the definition may be significantly improved.

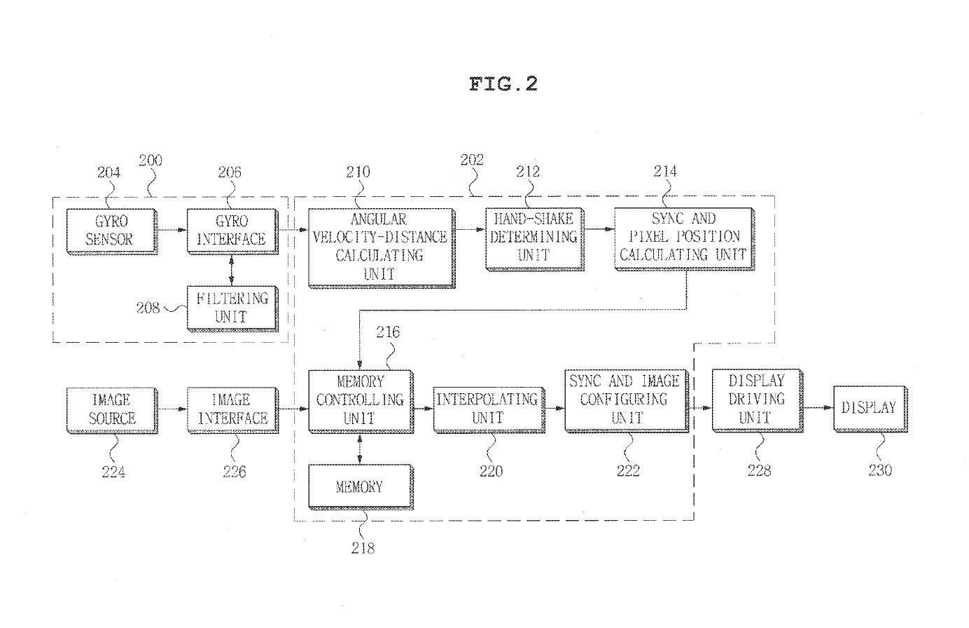

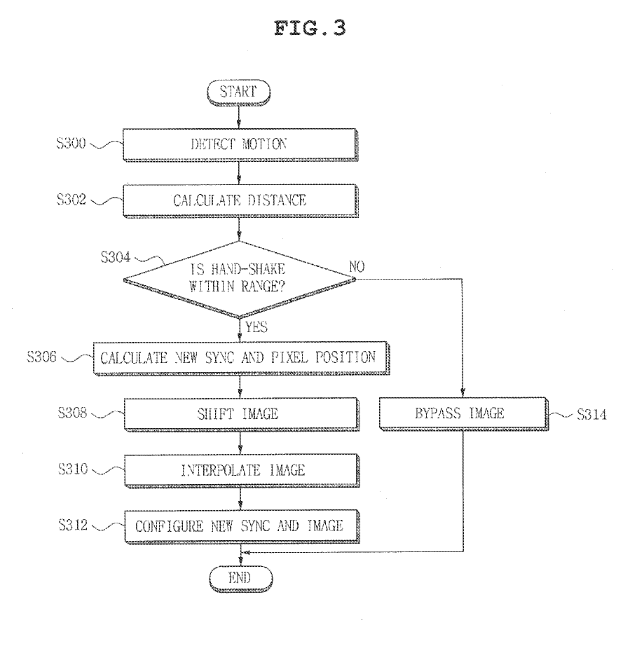

FIG. 2 is a block diagram of an apparatus for stabilizing an image of a display according to an embodiment of the invention, and FIG. 3 is a flow chart of a method for stabilizing an image of a display according to an embodiment of the invention.

Hereinafter, an apparatus and a method for stabilizing an image of a display according to various embodiments of the invention will be described with reference to FIGS. 2 and 3.

According to an embodiment, the apparatus for stabilizing the image of the display, as shown in FIG. 2, includes a motion detector 200 for detecting a motion of a display 230 in response to an external vibration or a shaking of a user and an image distortion corrector 202 for correcting positions of pixels of an image signal input into a display driver 228 based on an output of the motion detector 200.

According to an embodiment, the motion detector 200 includes a gyro sensor 204 for sensing the motion of the display 230, a gyro interface 206 for transforming and outputting an output format of the gyro sensor 204, and a filter 208 connected to the gyro interface 206 to thereby remove a drift error and an offset error from an output of the gyro sensor 204.

According to an embodiment, the image distortion corrector 202 includes an angular velocity-distance calculator 210 for calculating a movement distance of the display 230 based on an angular velocity output from the gyro interface 206, a sync and pixel position calculator 214 for calculating a new sync and pixel position based on the movement distance of the display 230 output from the angular velocity-distance calculator 210, a memory controller 216 for shifting positions of pixels of an image signal output through an image interface 226 by an image source 224, such as an application processor or an image signal processor based on an output of the sing and pixel position calculator 214, a memory 218 connected to the memory controller 216 and for storing the input image signal, an interpolator 220 for generating pixels to be filled in an empty space caused by the shift of the pixels in the image signal output from the memory controller 216, and a sync and image configuring unit 222 for configuring a sync and image for the interpolated image signal output from the interpolator 220.

According to an embodiment, the image distortion corrector 202 corrects the positions of the pixels of the image signal output from the image source 224 based on the motion detected by the motion detector 200 and provides the corrected pixels to the display driver 228.

According to an embodiment, the image distortion corrector 202 shifts the positions of the pixels of the image signal input into the display driver 228 to a direction opposite to a direction in which the display 230 is moved to thereby correct the image distortion caused by the motion of the display 230.

According to an embodiment, the image distortion corrector 202 further includes a hand-shake determining unit 212 for determining whether a hand-shake of the user is an intended hand-shake based on the output of the angular velocity-distance calculator 210 and providing a hand-shake determining signal and the movement distance of the display 230 output from the angular velocity calculator 210 to the sync and pixel position calculator 214.

According to an embodiment, the hand-shake determining unit 212 calculates a displacement amount accumulated during one frame period based on the output of the angular velocity-distance calculator 210 and compares the accumulated displacement amount with a predetermined reference value, thereby determining whether the hand-shake of the user is the intended hand-shake.

According to an embodiment, when the hand-shake determining signal output from the hand-shake determining unit 212 represents that the hand-shake of the user is the intended hand-shake, the sync and pixel position calculator 214 provides a signal which includes an indication of not calculating the new sync and pixel position and bypassing an original image signal to the memory controller 216.

According to an embodiment, the memory controller 216 reads out and outputs the image signal stored in the memory 218 depending on the new sync and pixel position output from the sync and pixel position calculator 214 to thereby shift the image to an X-Y-Z axis.

According to an embodiment, the image distortion corrector 202 corrects the positions of the pixels of the image signal input into the display driver 228 in an X-Y axis direction depending on a shaking of an X-Y axis of the display 230, when the gyro sensor 204 is a two-axis gyro sensor, and corrects the positions of the pixels of the image signal input into the display driver 228 in an X-Y-Z axis direction depending on a shaking of an X-Y-Z axis of the display 230, when the gyro sensor 204 is a three-axis gyro sensor.

Hereinafter, operations of the apparatus for stabilizing the image of the display according to various embodiments of the invention configured as described above will be described with reference to FIG. 2.

Assuming that the display 230 is shaken due to the external vibration, the hand-shake of the user, or the like. The gyro sensor 204 outputs an angular velocity in response to the shaking of the display 230. The angular velocity output from the gyro sensor 204 is filtered by the filter 208 to thereby remove the drift error and the offset error and is output through the gyro interface 206.

According to an embodiment, the gyro interface 206 serves to connect the gyro sensor 204 and the image distortion corrector 202 to each other. Currently, since most displays of smart devices have a refresh rate of 30 Hz, gyro data of 1 KHz, for example, is used.

According to an embodiment, the filter 208 uses, for example, a high pass filter (HPF) or a low pass filter (LPF) to remove the drift error and the offset error from the output of the gyro sensor 204.

According to an embodiment, the angular velocity-distance calculator 210 calculates the movement distance of the display 230 based on the angular velocity output from the gyro interface 206. The angular velocity-distance calculator 210 calculates the movement distance of the display 230 until a new sync frame is input using the angular velocity output from the gyro interface 206 to thereby calculate how much the position of the pixel is changed. When using gyro data of 1 KHz, for example, gyro data is accumulated 33 times between a frame and a frame in calculation. For example, assuming that the changes of 33 times of gyro data is present between an N−1 frame and an N frame, and a converting amount converting the accumulated angular velocity into the movement distance is X=2 mm, Y=2 mm, and Z=1 mm.

According to an embodiment, the hand-shake determining unit 212 calculates an accumulated displacement amount during one frame, that is, an accumulated displacement amount between a vertical sync and a vertical sync, based on the movement distance of the display 230 output from the angular velocity-distance calculator 210 and checks whether the accumulated displacement amount is within a preset range to thereby output the hand-shake determining signal. If the accumulated displacement amount is out of the preset range compared to a previous frame, the hand-shake determining signal indicating that the hand-shake of the user is the intended motion is output to the sync and pixel position calculator 214.

According to an embodiment, when the hand-shake determining signal output from the hand-shake determining unit 212 represents that the hand-shake of the user is the intended hand-shake, the sync and pixel position calculator 214 provides a signal which includes an indication of not calculating the new sync and pixel position and bypassing an original image signal to the memory controller 216 to thereby bypass the original image signal for the intended hand-shake of the user and not to correct the image distortion.

According to an embodiment of the invention, assuming that the hand-shake of the user is not the intended hand-shake, the hand-shake determining unit 212 provides the hand-shake determining signal indicating that the hand-shake of the user is not the intended hand-shake and the movement distance of the display 230 output from the angular velocity-distance calculator 210 to the sync and pixel position calculator 214. Since it is assumed that the converting amount converting the accumulated angular velocity into the movement distance is X=2 mm, Y=2 mm, and Z−1 mm, the movement distance of the display 230 during one frame is X=2 mm, Y=2 mm, and Z=1 mm.

According to an embodiment, the sync and pixel position calculator 214 calculates and outputs new sync and positions of pixels for shifting the pixels to a direction opposite to the movement direction of the display 230 based on the movement distance of the display 230. The sync and pixel position calculator 214 calculates how much the display 230 moves in the X-Y-X axis direction and how much a screen to be displayed on the display 230 is shifted based on the output of the angular velocity-distance calculator 210 input through the hand-shake determining unit 212. Assuming that the entire screen is moved in parallel during a short period of time.

According to an embodiment, the sync and pixel position calculator 214 first calculates a position of the X-Y axis in the opposite direction by the movement distance of X=2 mm and Y=2 mm as the pixel position. Assuming that a distance difference between a previous frame and a current frame from an eye of the user based on the position of the X-Y axis in the opposite direction by the movement distance, for example, the display 230 during one frame is moved forward by 1 mm, a position of the Z-axis is weighted by 1 mm to thereby correct the position of each pixel. The calculated position of each pixel is accessed in a ROM table scheme and a real time calculation is not required.

According to an embodiment, the memory controller 216 receives an image signal output from the image source 224 through the image interface 226 and shift the positions of the pixels of the received image signal based on the corrected new sync and pixel position output from the sync and pixel position calculator 214.

According to an embodiment, the memory 218 is connected to the memory controller 216 and stores the image signal input through the memory controller 216.

According to an embodiment, the memory controller 216 applies an offset to a new sync signal upon reading out the image signal stored in the memory 218 to thereby shift the entire image to the X-Y-Z axis, when the sync and pixel position calculator 214 completes the calculation of the distance which is needed to be moved to the X-Y-Z axis.

According to an embodiment, the image signal output from the memory controller 216 is an image signal which is shifted by a predetermined movement distance depending on the position calculated by the sync and pixel position calculator 214. Therefore, the interpolator 220 generates the pixels to be filled in the empty space caused by the shift of the pixels in the image signal output from the memory controller 216 by interpolating the pixels in the same frame to thereby generate the interpolated image signal.

According to an embodiment, the sync and image configuring unit 222 configures a sync and image for the interpolated image signal output from the interpolator 220 and provides the configured sync and image to the display driver 228, such that a clear image having no the shaking is displayed on the display 230.

In the apparatus for stabilizing the image of the display according to the preferred embodiment of the present invention, even in the case in which the display 230 is shaken due to the vibration or the hand-shake of the user in the environment in which the vibration is present, the distortion of the image displayed on the display 230 is corrected, such that the clear image having no the shaking is displayed, thereby making it possible to decrease the eye fatigue of the user and increase the quality of the image.

FIG. 3 is a flow chart of a method for stabilizing an image of a display according to an embodiment of the invention.

According to an embodiment, the method for stabilizing the image of the display will be described with reference to FIG. 3.

Assuming that the display 230 is shaken due to the external vibration, the hand-shake of the user, for example. In S300, the gyro sensor 204 outputs an angular velocity in response to the shaking of the display 230. The angular velocity output from the gyro sensor 204 is filtered by the filter 208 to thereby remove the drift error and the offset error and is output through the gyro interface 206.

In S302, the angular velocity-distance calculator 210 calculates the movement distance of the display 230 based on the angular velocity output from the gyro interface 206.

In S304, the hand-shake determining unit 212 calculates an accumulated displacement amount during one frame based on the movement distance of the display 230 output from the angular velocity-distance calculator 210, determines whether the accumulated displacement amount is within a preset range to thereby determine whether the hand-shake of the user is the intended hand-shake, and then outputs the hand-shake determining signal.

When the hand-shake determining signal output from the hand-shake determining unit 212 represents that the hand-shake of the user is the intended hand-shake, in S314, the sync and pixel position calculator 214 provides a signal, which includes an indication of not calculating the new sync and pixel position and bypassing an original image signal to the memory controller 216 to thereby bypass the original image signal for the intended hand-shake of the user and not to correct the image distortion.

When the hand-shake of the user is not the intended hand-shake, the hand-shake determining unit 212 provides the hand-shake determining signal indicating that the hand-shake of the user is not the intended hand-shake and the movement distance of the display 230 output from the angular velocity-distance calculator 210 to the sync and pixel position calculator 214.

In S306, the sync and pixel position calculator 214 calculates and outputs new sync and positions of pixels for shifting the pixels to a direction opposite to the movement direction of the display 230 based on the movement distance of the display 230.

In S308, the memory controller 216 shifts the positions of the pixels of the image signal output from the image source 224 and received through the image interface 226 based on the new sync and pixel position output from the sync and pixel position calculator 214.

According to an embodiment, the memory 218 is connected to the memory controller 216 and stores the image signal input through the memory controller 216.

According to an embodiment, the memory controller 216 reads out and outputs the image signal stored in the memory depending on the new sync and pixel position output from the sync and pixel position calculator 214 to thereby shift the image to an X-Y-Z axis.

According to an embodiment, the image signal output from the memory controller 216 is an image signal which is shifted by a predetermined movement distance depending on the position calculated by the sync and pixel position calculator 214. Therefore, in S310, the interpolator 220 generates the pixels to be filled in the empty space caused by the shift of the pixels in the image signal output from the memory controller 216 by interpolating the pixels in the same frame to thereby generate the interpolated image signal.

In S312, the sync and image configuring unit 222 configures a sync and image for the interpolated image signal output from the interpolator 220 and provides the configured sync and image to the display driver 228, such that a clear image having no the shaking is displayed on the display 230.

According to the various embodiments of the invention, the image transmitted from the application processor or the image signal processor to the display driver is corrected using the gyro sensor, with reference to image data in which the image correction is completed one time by the application processor, the image signal processor, as non-limiting examples.

According to an embodiment, the image in which all image processing are completed in the mobile device, such as the existing smart phone is reconfigured so as to match an actual situation, for example, the vibration environment such as the bus or subway, thereby making it possible to improve the quality of the displayed image.

In the apparatus and the method for stabilizing the image of the display according to an embodiment of the invention, even in the case in which the display is shaken due to the vibration or the hand-shake of the user, the distortion of the image displayed on the display is corrected, such that the clear image having no the shaking is displayed, thereby making it possible to decrease the eye fatigue of the user and increase the quality of the image.

According to an embodiment of the invention, even in the case in which the display of the mobile device, such as the smart phone or the tablet is shaken due to the vibration or the hand-shake of the user in the environment in which the vibration is present, the distortion of the image displayed on the display is corrected, such that the clear image having no shaking is displayed, thereby making it possible to decrease the eye fatigue of the user and increase the quality of the image.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An apparatus for stabilizing an image of a display, the apparatus comprising:
a motion detector configured to detect a motion of the display; and
an image distortion corrector configured to correct positions of pixels of an image signal input into a display driver based on an output of the motion detector.

2. The apparatus according to claim 1, wherein the image distortion corrector is further configured to correct the positions of the pixels of an image signal output from an application processor or an image signal processor based on the motion detected by the motion detector and configured to provide the corrected pixels to the display driver.

3. The apparatus according to claim 1, wherein the image distortion corrector is further configured to shift the positions of the pixels of the image signal input into the display driver to a direction opposite to a direction in which the display is moved to thereby correct image distortion due to the motion of the display.

4. The apparatus according to claim 1, wherein the motion detector comprises:
at least one gyro sensor configured to sense the motion of the display;
a gyro interface configured to transform and output an output format of the at least one gyro sensor; and
a filter connected to the gyro interface and configured to remove a drift error and an offset error from an output of the gyro sensor.

5. The apparatus according to claim 4, wherein the image distortion corrector comprises:
an angular velocity-distance calculator configured to calculate a movement distance of the display based on an angular velocity output from the gyro interface;
a sync and pixel position calculator configured to calculate a new sync and pixel position based on the movement distance of the display output from the angular velocity-distance calculator;
a memory controller configured to shift the positions of the pixels of an input image signal based on an output of the sync and pixel position calculator;
a memory connected to the memory controller and configured to store the input image signal;
an interpolator configured to generate pixels to be filled in an empty space caused by the shill of the pixels in the image signal output from the memory controller; and
a sync and image configuring unit configured to configure a sync and image for the interpolated image signal output from the interpolator.

6. The apparatus according to claim 5, wherein the image distortion corrector further comprises a hand-shake determining unit configured to determine whether a hand-shake of a user is an intended hand-shake based on the output of the angular velocity-distance calculator and configured to provide a hand-shake determining signal and the movement distance of the display output from the angular velocity-distance calculator to the sync and pixel position calculator.

7. The apparatus according to claim 6, wherein the hand-shake determining unit is configured to calculate a displacement amount accumulated during one frame based on the output of the motion detector and configured to compare the accumulated displacement amount with a predetermined reference value to thereby determine whether the hand-shake of the user is the intended hand-shake.

8. The apparatus according to claim 7, wherein when the hand-shake determining signal output from the hand-shake determining unit represents that the hand-shake of the user is the intended hand-shake, the sync and pixel position calculator is configured to provide a signal, which includes an indication of not calculating a new sync and pixel position and bypassing an original image signal to the memory controller.

9. The apparatus according to claim 5, wherein the memory controller is configured to read out and output the image signal stored in the memory depending on the new sync and pixel position output from the sync and pixel position calculator to thereby shift an image to an X-Y-Z axis.

10. The apparatus according to claim 4, wherein the image distortion corrector is configured to correct the positions of the pixels of the image signal input into the display driver in an X-Y axis direction depending on a shaking of an X-Y axis of the display, when the at least one gyro sensor is a two-axis gyro sensor, and further configured to correct the positions of the pixels of the image signal input into the display driver in an X-Y-Z axis direction depending on a shaking of an X-Y-Z axis of the display, when the at least one gyro sensor is a three-axis gyro sensor.

11. A method for stabilizing an image of a display, the method comprising:
(A) detecting a motion of the display by a motion detector; and
(B) correcting positions of pixels of an image signal input into a display driver based on an output of the motion detector.

12. The method according to claim 11, wherein the step (B) comprises correcting the positions of the pixels of an image signal output from an application processor or an image signal processor based on the motion detected by the motion detector and providing the corrected pixels to the display driver.

13. The method according to claim 11, wherein the step (B) comprises shifting the positions of the pixels of the image signal input into the display driver to a direction opposite to a direction in which the display is moved to thereby correct image distortion due to the motion of the display.

14. The method according to claim 11, wherein the step (B) comprises:
(B1) calculating a movement distance of the display based on an angular velocity in response to the motion of the display output from the step (A);
(B2) calculating a new sync and pixel position based on the movement distance of the display;
(B3) shifting the positions of the pixels of an input image signal based on the new sync and pixel position;
(B4) generating pixels to be filled in an empty space caused by the shift in the image signal in which the positions of the pixels are shifted in the step (B3) by interpolating pixels in the same frame to thereby generate an interpolated image signal; and
(B5) configuring a sync and image for the interpolated image signal.

15. The method according to claim 14, further comprising:
after the step (B1), (B1-1) determining whether a hand-shake of a user is an intended hand-shake based on the movement distance of the display and providing a hand-shake determining signal and the movement distance of the display calculated by the step (B1).

16. The method according to claim 15, wherein the step (B1-1) includes calculating a displacement amount accumulated during one frame based on the movement distance of the display and comparing the accumulated displacement amount with a predetermined reference value to thereby determine whether the hand-shake of the user is the intended hand-shake.

17. The method according to claim 15, wherein, when the hand-shake determining signal output from the step (B1-1) represents that the hand-shake of the user is the intended hand-shake, the step (B2) comprises outputting a signal, which includes an indication of not calculating a new sync and pixel position and bypassing an original image signal.

18. The method according to claim 14, wherein the step (B3) includes reading out and outputting the image signal stored in a memory depending on the new sync and pixel position to thereby shift the positions of the pixels of an image to an X-Y-Z axis.

19. The method according to claim 11, wherein, in the step (A), when the motion of the display depending on a hand-shake of a user is detected using at least one two-axis gyro sensor, the step (B) includes correcting the positions of the pixels of the image signal input into the display driver in an X-Y axis direction depending on a shaking of an X-Y axis of the display based on an output of the at least one two-axis gyro sensor, and
in the step (A) when the motion of the display depending on a hand-shake of a user is detected using at least one three-axis gyro sensor, the step (B) includes correcting the positions of the pixels of the image signal input into the display driver in an X-Y-Z axis direction depending on a shaking of an X-Y-Z axis of the display based on an output of the at least one three-axis gyro sensor.
